(19) United States
(12) Patent Application Publication
(10) Pub. No.: US 2021/0330048 A1
(43) Pub. Date: Oct. 28, 2021

(54) MICROFIBER CLOTH IN A TUBULAR CONTAINER

(71) Applicant: BRUCE SQUIER, Seattle, WA (US)

(72) Inventor: BRUCE SQUIER, Seattle, WA (US)

(21) Appl. No.: 16/858,328

(22) Filed: Apr. 24, 2020

(51) Int. Cl. A45C 11/04; G02C 13/00

(52) U.S. Cl. CPC A45C 11/043; A45C 13/1046; G02C 13/006

(57) ABSTRACT

An elongated container having a cap fitted to one end thereof, the other end being open. The cap is closed with an opening therethrough to the interior of the container. A microfiber cloth member is fittable within the container. A first drawstring extends from one end of the cloth member and a second drawstring extends from the other end thereof. The first drawstring includes a stop element at a free end thereof. The cloth member and the drawstrings are configured such that the cloth member can be moved in and out of the container by action on the first and second drawstrings.

### TECHNICAL FIELD

This invention relates generally to a cleaning device and more specifically concerns a cleaning device using an elongated storage container in combination with a cloth cleaner.

### BACKGROUND OF THE INVENTION

There is a well recognized need for an effective cleaning device for small implements such as eyeglasses, goggles and other small elements, or surfaces, such as computer screens, cell phone screens, and the like, particularly for those that require regular cleaning. Individual cloth pieces can be used, but it is often difficult to maintain availability of such cloth elements and for maintaining the cloth elements sufficiently clean to be effective. Previous solutions generally include a container for a cloth but most such arrangements are complicated, expensive and difficult to use effectively.

### SUMMARY OF THE INVENTION

[symbol]

### BRIEF DESCRIPTION OF THE DRAWINGS

FIG. 1A is an exterior view of the tubular portion of the present invention.

FIG. 1B is a cross-sectional view taken along the lines AA in FIG. 1A.

FIG. 2 is an elevational view of the microfiber cloth and drawstring portion of the present invention.

### BEST MODE FOR CARRYING OUT THE INVENTION

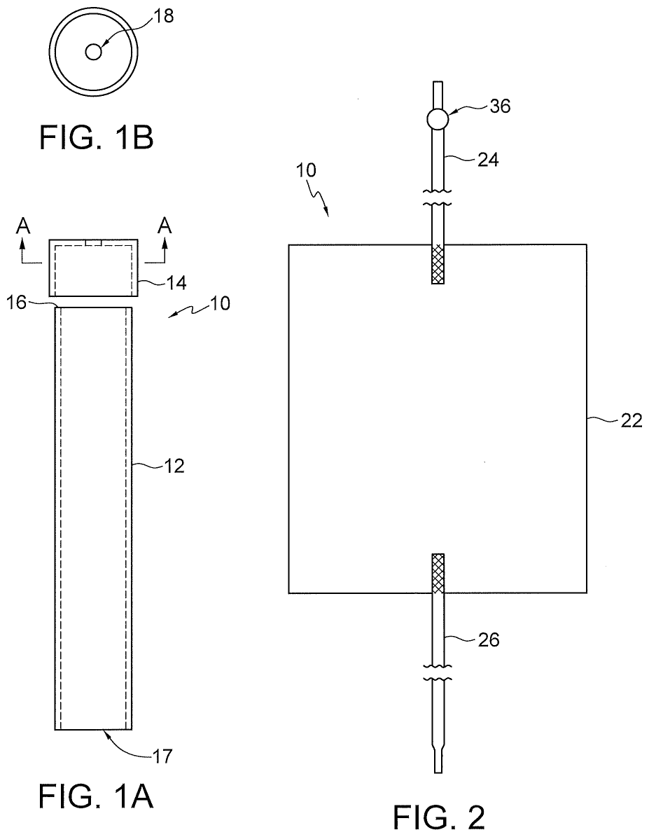

The present invention, referred to generally at 10 in FIGS. 1A, 1B, and 2, is a combination, which includes as a first part an elongated hollow container 12 having a cap 14 fitted to one end thereof. In the embodiment shown in FIGS. 1A and 1B, the container is typically tubular. The container and the cap are typically plastic. The cap 14 is press fitted to one end 16 of the tube 12. The other end 17 is always open. In the embodiment shown tube 12 is approximately 9 inches long and 1 inch in diameter (outside), although these dimensions can be varied, depending on the particular application. The cap 14 has an inside diameter slightly greater than the outside diameter of the tube 12, which allows it to be tightly fitted by hand to the tube. The cap is ¾ inch high in the embodiment shown. This includes an opening 18 typically in the center thereof, allowing access to the interior of the tube 12. The opening is ¼ inch in the embodiment shown.

The combination 10 also includes as a second part a cloth element 22, FIG. 2, in this embodiment a microfiber cloth element, approximately 7 inches wide by 7 inches long. The size of the tube and the cloth element can be varied. The microfiber cloth is sized to conveniently fit into the interior of tube 12. Two drawstring elements 24 and 26 are attached to and extend from opposing ends of the microfiber cloth element 22. One drawstring element is approximately 10 inches long in embodiment shown. The other drawstring is somewhat longer, 11 inches in the embodiment shown. The two drawstring elements are flexible cloth, approximately ¼ inch wide. Drawstring element 24 includes a stop element 36, such as a bead or a knot, in the vicinity of one end thereof. Stop element 36 is larger than the opening 18 in cap 14.

Initially, in use the cap 14 is apart from the tube. The second part of the combination is now combined with the first part. Drawstring element 26 is moved through opening 18 in the cap until the stop element abuts the opening in the cap. The drawstring element 26 is then moved through the tube 12 until it extends out the open end 17 of the tube. The drawstrings 26 then is pulled, moving the cloth element through the tube and out end 17 of the tube, until cap 14 comes into contact with end 18 of the tube and pressed fitted thereto by the user.

As indicated above, the microfiber cloth extends out end 17 of the tube. In this position, with the cap 14 press fitted to end 16 of tube 12 and stop element 36 against opening 18 in the cap, the microfiber cloth 22 is ready for use.

The microfiber cloth 22 can be conveniently moved back into the tube 12 in a stored portion by simply pulling on the end of drawstring element 24 with the stop element through cap 14, which remains in place on the end of the tube. In this stored position, the microfiber cloth is contained within the tube. The drawstring elements 24 and 26 extend a distance of 10 inches beyond the cap 14 and 9 ½ inches beyond the other, open end 17 of the tube 12. The cloth with drawstrings and the cap can be removed from the tube to permit cleaning of the cloth.

Thus, in operation, the cloth element is moved from a stored position in the tube by pulling on drawstring element 26 to an operational position extending from end 17 of tube 12, and then by pulling on drawstring element 24 to move the cloth element back into its stored position in tube 12. The stop element engaging with opening 18 on the cap prevents the drawstring element 26 and the cloth element from being pulled out the open end of the tube. The combination thus provides a reliable, efficient structure for alternatively using and storing a cloth element, preferably a microfiber cloth element.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. A cloth-based cleaning combination, comprising:
an elongated hollow container having a cap fitted to one end thereof, the other end being open, the cap being otherwise closed but having an opening therethrough to the interior of the elongated container; and
a microfiber cloth member fittable within the container with a first drawstring element connected to and extending from one end of the cloth member and having a stop member in the vicinity of a free end thereof, the stop member being larger that the opening in the cap, and a second drawstring member extending from an opposing end of the cloth member, wherein the first and second drawstring members, respectively, extend a distance beyond the one end and the other end of the container when the cloth member is within the container, the cloth member being moved into the container by pulling action on the first drawstring member, wherein the cloth member is moved out of the container for use thereof by a pulling action on the second drawstring member.

2. The combination of claim 1, wherein the container is a tube.

3. The combination of claim 1, wherein the first and second drawstring elements are flexible cloth.

4. The combination of claim 1, wherein the first and second drawstring elements are approximately ¼ inch wide.

5. The combination of claim 1, wherein the stop member is in the form of a knot.

6. The combination of claim 1, wherein the stop member is in the form of a bead.
